(19) United States
(12) Patent Application Publication
(10) Pub. No.: US 2025/0121497 A1
(43) Pub. Date: Apr. 17, 2025

(54) SYSTEMS AND METHODS FOR ELECTRIC CURRENT-BASED ROBOT COMMAND ALTERATION

(71) Applicant: Toyota Motor Engineering & Manufacturing North America, Inc., Plano, TX (US)

(72) Inventor: Robert C Huc, Cambridge (CA)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/487,191

(22) Filed: Oct. 16, 2023

(51) Int. Cl. B25J 9/16; B25J 9/12

(52) U.S. Cl. CPC B25J 9/1653; B25J 9/163; B25J 9/1651; B25J 9/126

(57) ABSTRACT

Systems, methods, and other embodiments described herein relate to altering a robot command instruction set to address operating inefficiencies of the robot. In one embodiment, a system includes a processor and a memory storing machine-readable instructions. The machine-readable instructions, when executed by the processor, cause the processor to 1) continuously monitor an electrical current used by a motor of a robot and 2) compare the electrical current to a secondary electrical current used by the robot. The machine-readable instructions also, when executed by the processor, cause the processor to 1) identify, from the electrical current and the secondary electrical current, an operating inefficiency of the robot command instruction set and 2) generate an alteration to the robot command instruction set, the alteration addresses the operating inefficiency.

### TECHNICAL FIELD

The subject matter described herein relates, in general, to automated robot control and, more particularly, to altering robot command instruction sets to address premature robot wear.

### BACKGROUND

Autonomous or semi-autonomous robots are used in a variety of industries. For example, multi-axis robots that imitate the movement of a human arm are used to perform any number of operations in a manufacturing facility. Multi-axis robots may be used in welding, part picking and handling, painting, and material removal applications, as well as others. As a specific example, a six-axis robot may include a grip that grasps one component from a storage bin and moves it towards an assembly line, where the component is joined with another component as the other component travels down an assembly line. In this and other examples, each axis (or joint) may include a motor, referred to herein as a joint motor, and a gearbox to facilitate joint movement. In general, enhancements to the robot's operation increases its utility and efficacy in executing a particular function.

### SUMMARY

In one embodiment, example systems and methods relate to a manner of altering a robot command instruction set to address operating inefficiencies of the robot.

In one embodiment, a motor control system for altering a robot command instruction set is disclosed. The motor control system includes one or more processors and a memory communicably coupled to the one or more processors. The memory stores instructions that, when executed by the one or more processors, cause the one or more processors to continuously monitor an electrical current used by a motor of a robot and compare the electrical current to a secondary electrical current used by the robot. The memory also stores instructions that, when executed by the one or more processors, cause the one or more processors to 1) identify, from the electrical current and the secondary electrical current, an operating inefficiency of the robot command instruction set and 2) generate an alteration to the robot command instruction set, the alteration addresses the operating inefficiency.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a motor control system that is associated with altering a robot command instruction set to address operating inefficiencies of the robot.

FIG. 2 illustrates one embodiment of a multi-axis robot and the alteration of the robot command instruction set based on electrical currents.

FIG. 3 illustrates one embodiment of the motor control system of FIG. 1.

FIG. 4 illustrates a flowchart for one embodiment of a method that is associated with altering a robot command instruction set to address operating inefficiencies of the robot.

### DETAILED DESCRIPTION

Systems, methods, and other embodiments associated with improving a robot command instruction set to address operating inefficiencies of the robot. As previously described, autonomous robots are seeing increased use in society with no indication that the rate of increase is slowing. However, as with all mechanical devices, these autonomous robots are susceptible to failure and wear. Wear on these robots reduces the effective life cycle of the robots and leads to downtime and a loss of utility as the robot wear is addressed via repair and/or replacement. In some cases, the robot command instruction set contributes to the premature wear and expiration of these robots. The robot command instruction set refers to machine-readable instructions that, when executed by a processor, cause the processor to effectuate some movement or operation of the robot. For example, the robot command instruction set may trigger the provision of an electrical current to a motor of a robot to move a component (e.g., a joint) of the robot. However, some robot programming may generate inefficient movements that increase the wear on the robot. For example, the movement of a joint of a multi-axis robot that is quicker than needed may result in an above threshold and wear-increasing torque and/or acceleration on the joint. As such, some robot command instruction sets generate movements that do not minimize the torque and acceleration seen by the motor/joint. As torque and acceleration lead to premature wear of that motor/joint, such robot command instruction sets may result in the aforementioned downtime and loss of utility.

Accordingly, the system of the present specification leverages the use of electrical current data for robots (which electrical current data correlates to torque and acceleration of the motor) and machine-learning systems to identify potential risk conditions and opportunities to alter the robot command instruction set to reduce a premature wear of the robot. As a particular example, it may be desirable for a manufacturing robot to complete a task on an article in 60 seconds so that the article can be passed to a downstream section of the manufacturing operation. In this example, the manufacturing robot may be programmed to complete the task in 40 seconds. The quicker-than-needed operation of the manufacturing robot may induce higher stresses/loads on the robot and lead to premature wear on the joints of the robot. In this example, the system may identify the idle portion of the cycle (e.g., 20 seconds) and alter the robot command instruction set for this manufacturing robot such the task is performed in closer to 60 seconds. This reduces the torque and acceleration on the robot and extends its operating life.

In this way, the disclosed system and other embodiments improve robot operation by 1) automating the assessment by systemizing data collection and evaluation, 2) standardizing the assessment via machine learning, 3) continually assessing non-ideal changes closer to the time of occurrence, 4) prioritizing using a scoring calculation, and 5) extending the life of robot components. That is, the present system improves the operation of robots, such as manufacturing robots, by enabling the detection of features of the robot command programming/instruction set that may lead to premature wear of the robot, thus elongating the robot's effective life, reducing robot downtime, and overall increasing the productivity of the robot.

The discussion below outlines numerous specific details to provide a thorough understanding of the embodiments described herein. Those of skill in the art, however, will understand that the embodiments described herein may be practiced using various combinations of these elements.

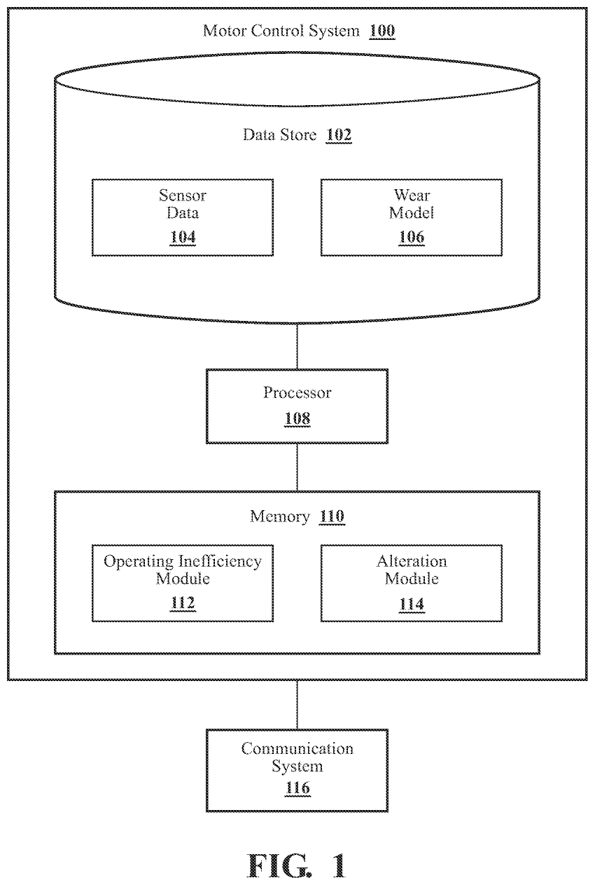

FIG. 1 illustrates one embodiment of a motor control system 100 that is associated with altering a robot command instruction set to address operating inefficiencies of the robot. The motor control system 100 that is implemented to perform methods and other functions as disclosed herein, relates to improving robot command instruction sets to address operating inefficiencies of the robot command instruction set.

The motor control system 100 functions in cooperation with a communication system 116 to communicate with a robot. In one example, the communication system 116 is a wired communication system with the motor control system 100 and the robot each including physical ports that receive a cable connector to effectuate data transmission between the two.

In another example, the communication system 116 is wireless. In this example, the communication system 116 communicates according to one or more communication standards. For example, the communication system 116 can include multiple different antennas/transceivers and/or other hardware elements for communicating at different frequencies and according to respective protocols. The communication system 116, in one arrangement, communicates via a communication protocol, such as a WiFi, DSRC, or another suitable protocol for communicating with the robot. Moreover, the communication system 116, in one arrangement, further communicates according to a protocol, such as global system for mobile communication (GSM), Enhanced Data Rates for GSM Evolution (EDGE), Long-Term Evolution (LTE), 5G, or another communication technology that provides for the robot communicating with various remote devices (e.g., a cloud-based server). In any case, the motor control system 100 can leverage various wireless communication technologies to provide communications to other entities, such as robots.

The motor control system 100 is shown as including a processor 108. Accordingly, the processor 108 may be a part of the motor control system 100, or the motor control system 100 may access the processor 108 through a data bus or another communication path. In one or more arrangements, the processor(s) 108 can be a primary/centralized processor of the motor control system 100 or may be representative of many distributed processing units. For instance, the processor(s) 108 can be an electronic control unit (ECU). Alternatively, or additionally, the processors include a central processing unit (CPU), an ASIC, a microcontroller, a system on a chip (SoC), and/or other electronic processing units that support operation of the motor control system 100.

In one embodiment, the motor control system 100 includes a memory 110 that stores an operating inefficiency module 112 and an alteration module 114. The memory 110 is a random-access memory (RAM), read-only memory (ROM), a hard-disk drive, a flash memory, or another suitable memory for storing the modules 112 and 114. The modules 112 and 114 are, for example, computer-readable instructions that, when executed by the processor 108, cause the processor 108 to perform the various functions disclosed herein. In alternative arrangements, the modules 112 and 114 are independent elements from the memory 110 that are, for example, comprised of hardware elements. Thus, the modules 112 and 114 are alternatively ASICs, hardware-based controllers, a composition of logic gates, or another hardware-based solution.

Moreover, in one embodiment, the motor control system 100 includes the data store 102 for storing one or more types of data. The data store 102 is, in one embodiment, an electronic data structure stored in the memory 110 or another data storage device and that is configured with routines that can be executed by the processor 108 for analyzing stored data, providing stored data, organizing stored data, and so on. The data store 102 can be comprised of volatile and/or non-volatile memory. Examples of memory that may form the data store 102 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 102 is a component of the processor(s) 108. In general, the data store 102 is operatively connected to the processor(s) 108 for use thereby. The term “operatively connected,” as used throughout this description, can include direct or indirect connections, including connections without direct physical contact.

In one embodiment, the data store 102 stores data used by the modules 112 and 114 in executing various functions. In one embodiment, the data store 102 stores the sensor data 104 along with, for example, metadata that characterizes various aspects of the sensor data 104. For example, the metadata can include relative map coordinates or tile identifiers, time/date stamps from when the separate sensor data 104 was generated, identifiers of the robots associated with the sensor data 104, and so on.

The sensor data 104 is data provided by one or more robot sensors. That is, the robot may include one or more sensors. As described herein, “sensor” means an electronic and/or mechanical device that generates an output (e.g., an electric signal) responsive to a physical phenomenon, such as an electrical current, sound, etc. The sensors can be operatively connected to the processor(s) 108, the data store(s) 102, and/or another element of the motor control system 100. While various examples of different types of sensors may be described herein, it will be understood that the embodiments are not limited to the particular sensors described.

In general, the sensor monitors a condition of a motor of the robot and communicates such to the motor control system 100 via the communication system 116. In a particular example, the sensor is an electrical current sensor that detects the current flowing to a motor. In one example, the electrical current sensor detects the current flow along an electrical wire by measuring or sensing the magnetic field generated by the flow of electrical current. While one particular example of an electrical current sensor is described herein, the electrical current sensor may take various forms.

In any example, the electrical current data collected by the electrical current sensor is passed to the motor control system 100 and stored as sensor data 104. In an example, the sensor data 104 may include electrical current data for multiple motors. For example, a single robot may include multiple motors. As a specific example, a multi-axis robot may include a motor per joint to effectuate movement at that joint. In this example, the motor control system 100 receives sensor data, e.g., electrical current data, for each joint motor. As another example, the motor control system 100 may control the operation of multiple robots. As such, the motor control system 100 receives electrical current data from these multiple robots and, in some cases, multiple motors of the multiple robots. As noted above, such information is received from the robots via the communication system 116.

In one embodiment, the data store 102 further includes a wear model 106, which facilitates the detection of premature wear of a monitored motor. That is, as described above, the robot command instruction set may operate a motor in a fashion that leads to wear on the motor. The robot command instruction set dictates how the motor operates to move the robot or a component of the robot. This movement subjects the motor to torque and acceleration forces which cause the motor to wear. If the torque and acceleration forces are of sufficient magnitude, the motor may wear at a faster-than-desirable rate or a rate that is quicker than expected. The electrical current used by a particular motor may map to the torque and acceleration forces seen by the motor, thereby indicating the load/wear on the motor. As such, the operating inefficiency module 112 may detect premature wear of a motor of a robot by analyzing the electrical current data associated with the motor of the robot. The wear model 106 includes the weights, variables, algorithms, parameters, etc., or other data that allow the operating inefficiency module 112 to identify, based on electrical current data, operating conditions where intervention could increase the life of the robot.

As described previously, the motor control system 100 can include one or more modules, at least some of which are described herein. In at least one arrangement, the modules are implemented as non-transitory computer-readable instructions that, when executed by the processor 108, implement one or more of the various functions described herein. In various arrangements, one or more of the modules are a component of the processor(s) 108, or one or more of the modules are executed on and/or distributed among other processing systems to which the processor(s) 108 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

The operating inefficiency module 112, in one embodiment, includes instructions that cause the processor 108 to continuously monitor an electrical current used by a motor of the robot. As such, the operating inefficiency module 112 generally includes instructions that function to control the processor 108 to receive data inputs from one or more sensors of the robots to which it is connected. That is, a robot may include any number of sensors that collect data regarding the operation of the robot. In one example, the sensed data is the electrical current used by the motors of the robot. As such, the inputs to the operating inefficiency module 112 are, in one embodiment, electrical currents used by the motors of the robot. As noted, such monitoring may be continuous. That is, rather than acquiring electrical current data responsive to a triggering event such as a noted failure or manual notification by an engineer, the operating inefficiency module 112 may continuously extract sensor data 104 from the data store 102, which sensor data 104 is continuously received from the sensors of the robots.

Accordingly, the operating inefficiency module 112, in one embodiment, controls the respective sensors to provide the data inputs in the form of the sensor data 104. Additionally, while the operating inefficiency module 112 is discussed as controlling the various sensors to provide the sensor data 104, in one or more embodiments, the operating inefficiency module 112 can employ other techniques to acquire the sensor data 104 that are either active or passive. For example, the operating inefficiency module 112 may passively sniff the sensor data 104 from a stream of electronic information provided by the various sensors to the motor control system 100.

The operating inefficiency module 112, in one embodiment, also includes instructions that cause the processor 108 to compare the electrical current to a secondary electrical current used by the robot and identify, from the comparison, an operating inefficiency of the robot command instruction set. That is, an operating inefficiency may occur when the electrical current used by a robot is different from a secondary electrical current by a threshold amount. Such a difference may indicate an unequal distribution of load across the motors of the robot. Redistribution of this load may prevent the premature wear of the motor, which is subject to a greater load.

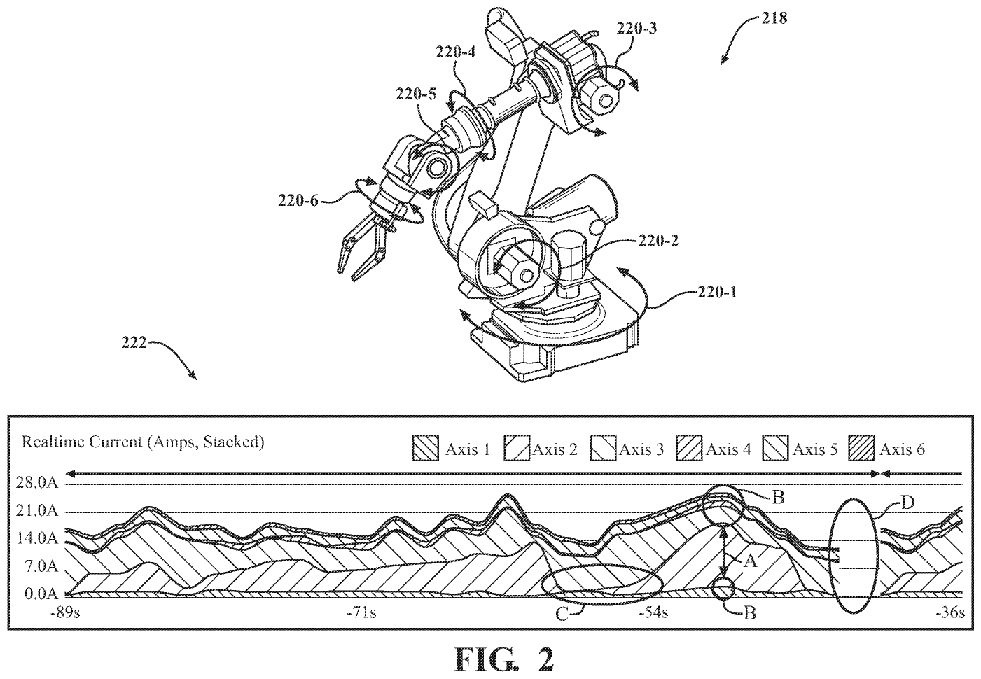

In an example, the secondary electrical current may be a predetermined threshold electrical current for the motor. For example, a manufacturer, engineer, or other entity may indicate that an electrical current greater than 20 amperes may damage a particular motor. In this example, an electrical current used by the motor within a threshold distance of this electrical current (e.g., 15 amperes) may indicate an operating inefficiency that can be addressed by altering the robot command instruction set. By comparison, an electrical current value of 5 amperes may not trigger any inefficiency-based alteration of the robot command instruction set. As such, the operating inefficiency module 112 may compare a point in time or averaged electrical current value to this predetermined threshold electrical current to identify a potential operating inefficiency. FIG. 2 below provides an example of near-threshold electrical currents indicating an operating inefficiency. In practice, the threshold difference may be any value, including 5%, 10%, 20%, or any numerical value, and may be set by a machine-learning algorithm.

In an example, the secondary electrical current may be a current used by the same motor at a different point in time. For example, at a first point in time, the electrical current used by a first motor of a multi-axis robot may be a first value, while at a second point in time, the electrical current used by the first motor may be a second value, which second value is greater than the first value. In this scenario, a more optimal robot command instruction set may be one where the operation of the robot is such that the first value and the second value are more similar, thus reducing the wear associated with the second point in time as indicated by the higher electrical current. As such, in this example, the operating inefficiency module 112 compares the electrical current used by the first motor at different points in time to determine whether a difference between them is greater than a threshold amount to trigger intervention. FIG. 2 below provides an example of a temporal difference between electrical currents indicating an operating inefficiency. In practice, the threshold difference may be any value, including 5%, 10%, 20%, or any numerical value, and may be set by a machine-learning algorithm.

In another example, the secondary electrical current may be a current used by a different motor at the same time. For example, at a point in time, the electrical current used by a first motor may be a first value, while at the same point in time, the electrical current used by a second motor may be a second value that is less than the first value. In this scenario, a more optimal robot command instruction set may be one where the operation of the robot is such that part of the load of the first motor, as indicated by the increased electrical current, is shifted to the second motor, thus preventing premature wear on the first motor. As such, in this example, the operating inefficiency module 112 compares the electrical currents used by the first and second motors to determine whether a difference between them is greater than a threshold amount to trigger intervention. FIG. 2 depicts an example of a motor-based difference between the secondary electrical current and the electrical current. In practice, the threshold difference may be any value, including 5%, 10%, 20%, or any numerical value, and may be set by a machine-learning algorithm.

In either case, the operating inefficiency module 112 may execute machine learning to compare the different electrical currents and identify the operating inefficiency of the robot command instruction set based on the comparison. That is, the operating inefficiency module 112 may be a machine-learning module that determines whether certain sensor data 104 (i.e., electrical current data for motors) indicates 1) premature wear or 2) an expected operating condition for the motor. For example, the operating inefficiency module 112 may set the threshold by which it is determined whether a difference in electrical current (either 1) a threshold-based difference, 2) a time-based difference of electrical current at a single motor, or 3) a difference between electrical current used by multiple motors), is a sign of an undesirable load that could lead to premature wear. In an example, such a determination may be made based on historical data for this motor or other potentially similar motors. That is, the operating inefficiency module 112 is trained on a dataset of a particular motor or multiple, and potentially similar, motors, which dataset correlates electrical current values and/or electrical current value differences (either for the same motor or between different motors) to premature wear conditions and/or an above threshold torque/acceleration.

In one configuration, the machine learning algorithm is embedded within the operating inefficiency module 112, such as a convolutional neural network (CNN), to perform electrical current comparison and the operating condition inefficiency identification based on the comparison. Of course, in further aspects, the operating inefficiency module 112 may employ different machine learning algorithms or implement different approaches for performing the electrical current comparison and the operating inefficiency identification. Whichever particular approach the operating inefficiency module 112 implements, the operating inefficiency module 112 provides an output with operating inefficiencies represented in the sensor data 104. In this way, operating inefficiencies in the day-to-day operation of the robot can be altered to prevent or reduce the likelihood of premature wear.

A machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the motor control system 100 or another system generally trains the machine learning algorithm according to a particular training approach, which may include supervised training, self-supervised training, reinforcement learning, and so on. In contrast to training/learning of the machine learning algorithm, the motor control system 100 implements the machine learning algorithm to perform inference. Thus, the general use of the machine learning algorithm is described as inference.

It should be appreciated that the operating inefficiency module 112 in combination with the wear model 106 can form a computational model such as a neural network model. In any case, the operating inefficiency module 112, when implemented with a neural network model or another model, in one embodiment, implements functional aspects of the wear model 106 while further aspects, such as learned weights, may be stored within the data store 102. Accordingly, the wear model 106 is generally integrated with the operating inefficiency module 112 as a cohesive functional structure.

The motor control system 100 also includes an alteration module 114 which, in one embodiment, includes instructions that cause the processor 108 to generate an alteration to the robot command instruction set. Specifically, the alteration is implemented to address the operating inefficiency. The alteration may take various forms and, in general, may even out the electrical current usage for the motor(s) of the robot. For example, as described above, the operating inefficiency may be that the motor operates more quickly than needed to complete a task. That is, there may be an idle portion of a cycle of the motor. In this example, the alteration may be to slow down the operation of the motor such that the robot completes the task closer to the task window. Doing so reduces the load/electrical current usage as the movements executed during a quick task may introduce unnecessary load on the motor. In another example, the alteration may be to adjust the timing of operations. For example, a joint motor of a multi-axis robot may control the movement of a head of the robot in a particular fashion at a particular point in time. In this example, it may be the case that the particular movement of the head may be made at an earlier point in time without affecting the operating task of the robot. Doing so may even out the time-based electrical current values for this joint motor. These and other examples provided below reduce the wear/load on the motor(s) of the robot, thus increasing the life of the robot and decreasing premature wear of the motor(s) of the robot.

In an example, the alteration module 114 may execute machine learning to generate the alteration of the robot command instruction set. As such, the alteration module 114 may be a machine-learning module that determines what alteration to make based on a determined operating inefficiency. For example, for given electrical current values and secondary electrical current values, the alteration module 114 may output a particular alteration to the robot command instruction set determined to reduce the operating inefficiency. In an example, such a determination may be made based on historical data for this motor or other potentially similar motors. That is, the alteration module 114 is trained on a dataset of a particular motor or multiple, and potentially similar, motors, which dataset correlates detected operating inefficiencies, associated program instruction set alterations, and whether such alterations resolved the operating inefficiencies.

In one configuration, the machine learning algorithm is embedded within the alteration module 114, such as a convolutional neural network (CNN), to perform instruction set alteration generation. Of course, in further aspects, the alteration module 114 may employ different machine learning algorithms or implement different approaches for performing instruction set alteration generation. Whichever particular approach the alteration module 114 implements, the alteration module 114 provides an output of instruction set alterations based on determined operating inefficiencies. In this way, operating inefficiencies in the day-to-day operation of the robot can be altered to prevent or reduce the likelihood of premature wear.

A machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the motor control system 100 or another system generally trains the machine learning algorithm according to a particular training approach, which may include supervised training, self-supervised training, reinforcement learning, and so on. In contrast to training/learning of the machine learning algorithm, the motor control system 100 implements the machine learning algorithm to perform inference. Thus, the general use of the machine learning algorithm is described as inference.

The motor control system 100 may, via the communication system 116, output the altered robot command instruction set in various ways. In one example, the output is a notification, message, or warning to an engineer that an operating inefficiency exists. In this example, the motor control system 100 provides an individual such as an engineer or technician with the operating inefficiency information and context so that the individual may take appropriate remedial action to address the inefficiency. In a further example, the output may indicate a severity or other contextual data regarding the inefficiency. For example, FIG. 2 below depicts an example graph of the electrical currents of multiple motors of a multi-axis robot over time. In this example, the graph or a similar representation, along with superimposed indications of inefficiency-based electrical current values, may be presented to a user via a display device.

In another example, the motor control system 100 may alter the robot command program instruction set. That is, the motor control system 100 may transmit, via the communication system 116, a command to alter a robot command instruction set in a particular way based on a detected operating inefficiency. In any case, the motor control system 100 of the present specification improves the routine operation of the motor by 1) identifying conditions (e.g., uneven electrical current usage at a motor of a robot and/or uneven electrical current usage across motors of a robot) that may lead to premature wear on the robot and 2) altering the robot command instruction set to prevent or reduce the condition leading to premature wear (i.e., make the electrical current usage of the motor more even and/or reduce the electrical current difference between different motors of the robot).

FIG. 2 illustrates one embodiment of a multi-axis robot 218 and the robot command instruction set alteration based on electrical currents. Specifically, FIG. 2 depicts a six-axis robot 218. As depicted, the robot has six axes or joints 220-1, 220-2, 220-3, 220-4, 220-5, and 220-6, each controlled by a separate joint motor. The joint motors convert electrical energy into mechanical energy and draw electrical current. FIG. 2 also depicts a stacked graph 222 indicating electrical current usage over time for each joint motor, with time represented on the x-axis and current represented on the y-axis. FIG. 2 also depicts electrical current usages representative of various operating inefficiencies. As described, the motor control system 100 monitors the electrical current of a motor. In this example, the motor control system 100 includes instructions that, when executed by the processor 108, cause the processor 108 to continuously monitor an electrical current used by each joint motor of a multi-axis robot.

As described above, the stacked graph 222 depicts various circumstances indicative of an operating inefficiency of the robot command instruction set. First, at point A, an electrical current of the joint motor at the second joint 220-2 may be within a threshold distance from an operating maximum for this second joint motor. That is, the operating inefficiency module 112 may identify an operating inefficiency at point A due to the electrical current at that time being within a threshold distance of a maximum value prescribed for that joint motor. As such, the alteration module 114 may generate an alteration to the robot command instruction set that reduces the electrical current and associated load on the second joint 220-2 at this point.

As described above, an operating inefficiency may occur when the electrical current used by one motor (e.g., a joint motor) is a threshold amount greater than the electrical current used by another motor. That is, the secondary electrical current may be an electrical current used by a different motor of the robot, and the operating efficiency is identified based on a difference between the electrical current and the secondary electrical current. FIG. 2 indicates this scenario where the electrical current used by the joint motor of the second joint 220-2 at point A, is greater than the electrical current used by other joint motors at the same time, i.e., point B by some threshold amount, which threshold amount may be determined by a machine-learning algorithm.

In this example, the alteration module 114 may provide a notification of a recommended change or automatically change the operation of any of the joint motors to reduce the difference between the electrical current of the second joint motor and the other joint motors, which alteration may be determined by a machine-learning algorithm. For example, it may be that multiple joints can effectuate the same movement. As such, rather than actuating the second joint motor to perform a particular maneuver, the robot may actuate another joint motor (such as the third joint motor, the fifth joint motor, or a combination of these and other joint motors) to effectuate the same movement. As such, the load of the second joint motor is reduced and made more consistent with the load of the other joint motors. Accordingly, in this example, the motor control system 100 operates to reduce the difference in electrical loads on the different motors of a robot by apprising an engineer of the operating inefficiency or automatically changing the operation of the robot to address the inefficiency.

As another example, an operating inefficiency may occur when the electrical current used by one joint motor is a threshold amount greater than that used by the same joint motor at a different point in time. That is, the secondary electrical current may be a current used by the motor at a different point in time, and the operating efficiency is identified based on a difference between the electrical current and the secondary electrical current. FIG. 2 indicates this scenario where the electrical current used by the joint motor at the second joint 220-2 is greater at one point in time, point A, than the electrical current used by the same second joint motor at another point in time, point C by some threshold amount, which threshold amount may be determined by a machine-learning algorithm.

In this example, the alteration module 114 may notify an engineer of the operating inefficiency or automatically change the operation of the motor to reduce the difference between the electrical current of the second joint motor and the different points in time, which alteration may be determined by a machine-learning algorithm. For example, it may be that a particular movement of the second joint 220-2 may occur at different points in time across a cycle. As such, rather than actuating the second joint 220-2 to perform a particular maneuver at a particular point in time, point A, the motor may actuate the second joint 220-2 to perform the particular maneuver at a second point in time, point C. As such, the load of the second joint motor is reduced and made more consistent across time. As such, in this example, the motor control system 100 operates to reduce the difference of electrical load on a single motor over time.

As a specific variation of this last example, an operating inefficiency may occur when the secondary electrical current used by the same motor at a different point in time is zero. That is, the secondary electrical current is a zero-value electrical current indicating an idle portion of a cycle of the robot as depicted at point D. As such, the second joint motor (as well as the other joint motors) may be experiencing a peak load that would be unnecessary were the idle portion of shorter duration or non-existent. In this example, the alteration module 114 may change the operation of the joint motor to reduce the operating speed of the joint motor to reduce the duration of the idle portion. While the overall current used by the joint motor may not be reduced, the peak values are reduced, which reduces the electrical current peak value and the peak torque, acceleration, or other load seen at the second joint motor. Reducing the peak/spike values of electrical current increases the life of the respective joint motor.

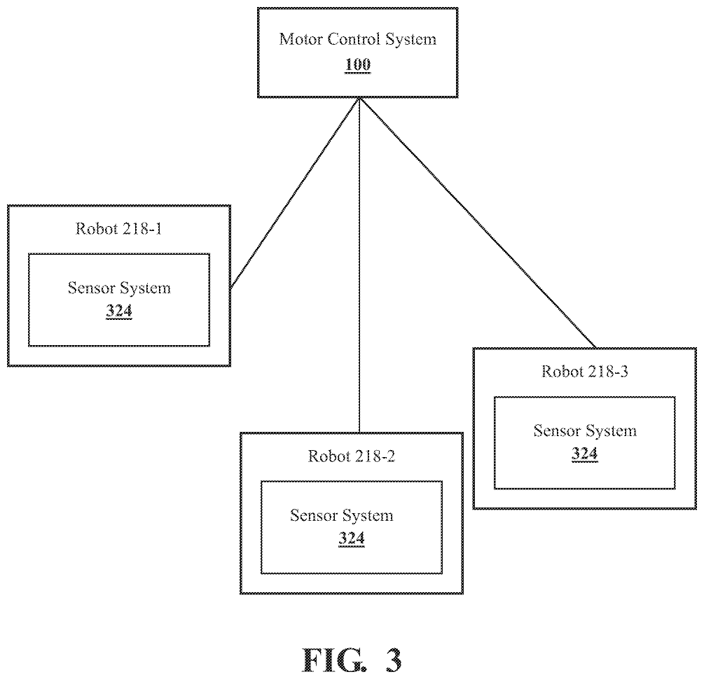

FIG. 3 illustrates one embodiment of the motor control system 100 of FIG. 1. As described above, the motor control system 100 may manage a fleet of robots 218-1, 218-2, and 218-3. As such, the communication system 116 of the motor control system 100 may be communicatively coupled to each of the robots 218-1, 218-2, and 218-3. Via this communication system 116, whether wireless or wired, the motor control system 100 may receive sensor data 104 from the sensor systems 324 of the respective robots 218-1, 218-2, and 218-3. Moreover, in the example where the motor control system 100 outputs command alterations rather than a message/notification to a user, the communication system 116 facilitates the transmission of the alteration commands to the respective robots 218-1, 218-2, and 218-3.

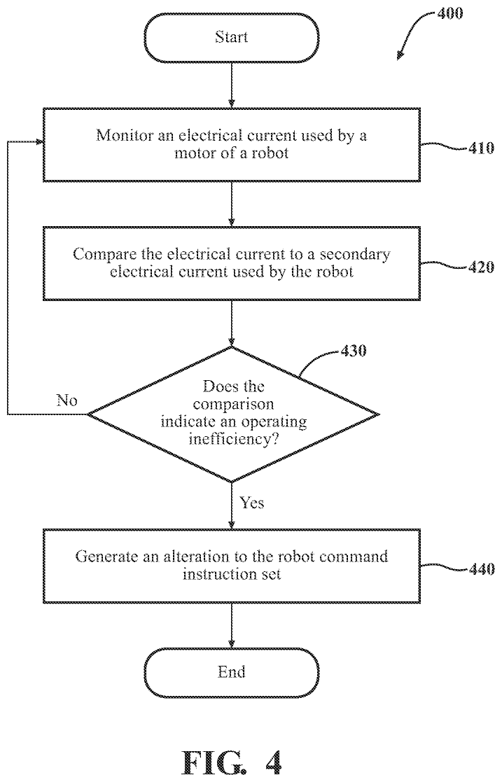

Additional aspects of altering robot command instruction sets will be discussed in relation to FIG. 4. Method 400 will be discussed from the perspective of the motor control system 100 of FIG. 1. While method 400 is discussed in combination with the motor control system 100, it should be appreciated that the method 400 is not limited to being implemented within the motor control system 100 but is instead one example of a system that may implement the method 400.

At 410, the operating inefficiency module 112 monitors an electrical current used by at least one motor of a robot. In some examples as described above, the operating inefficiency module 112 of the motor control system 100 monitors the electrical current usage of multiple motors. As such, the motor control system 100 communicates with robots 218-1, 218-2, and 218-3 to acquire the sensor data 104.

In further embodiments, the operating inefficiency module 112 communicates with the robots 218-1, 218-2, and 218-3 to acquire the sensor data 104 at successive iterations or time steps. Thus, in one embodiment, the motor control system 100 iteratively executes the functions discussed at blocks 410-430 to acquire the sensor data 104 and provide information therefrom. Furthermore, the operating inefficiency module 112, in one embodiment, executes one or more of the noted functions in parallel for separate observations in order to maintain updated perceptions.

At 420, the operating inefficiency module 112 compares the electrical current to a secondary electrical current. As described above, the secondary electrical current may be 1) a threshold current for the motor, 2) an electrical current from the same motor at a different point in time, and/or 3) an electrical current from a different motor at the same time. In any case, the difference between the electrical current and a secondary electrical current may indicate an operating efficiency. As such, at 430, the operating inefficiency module 112 evaluates whether the electrical current measurements indicate an operating inefficiency, as described above. If not, the operating inefficiency module 112 continues monitoring the electrical currents. If the electrical current measurements indicate an operating efficiency, at 440, the alteration module 114 generates an alteration to the robot command instruction set. For example, the alteration module 114 may alter the operation of the motor or other motors to even out the electrical current usage across motors or time or may notify an engineer such that the engineer may alter the motor operation as described above.

In an example, the alteration module 114 may prioritize detected operating inefficiencies to sequentially address issues that arise. For example, the alteration module 114 may include an instruction that, when executed by the processor 108, causes the processor 108 to rank operating inefficiencies of multiple motors of the robot and select, based on a ranking, a motor of the robot for which an alteration is generated. For example, the ranking may be based on electrical current differences with greater electrical current differences being ranked higher and prioritized. As such, in a given cycle, i.e., daily, the operating inefficiency module 112 may monitor and identify several operating inefficiencies exhibited by a robot. In this example, the alteration module 114 may select a top quantity of those operating inefficiencies to address via robot command instruction set alterations. This process may be repeated over a number of cycles such that multiple issues are addressed in each cycle.

Similarly, in an example, the alteration module 114 may include an instruction that, when executed by the processor 108, causes the processor 108 to rank operating inefficiencies of multiple motors of multiple robots and select, based on a ranking, a motor of the robot for which an alteration is generated. That is, in this example, rather than ranking the motors of a single robot, the alteration module 114 ranks the motors of multiple robots based on electrical current differences with greater electrical current differences being ranked higher and therefore prioritized. As such, in a given cycle, i.e., daily, the operating inefficiency module 112 may monitor and identify a number of operating inefficiencies exhibited by the robots. In this example, the alteration module 114 may select a top quantity of those operating inefficiencies to address via robot command instruction set alterations. This process may be repeated over a number of cycles such that multiple issues are addressed in each cycle.

In this way, the disclosed system and other embodiments improve robot operation by 1) automating the assessment by systemizing data collection and evaluation, 2) standardizing the assessment via machine learning, 3) continually assessing non-ideal changes closer to the time of occurrence, 4) prioritizing using a scoring calculation, and 5) extending the life of robot components. That is, the present system improves the operation of robots, such as manufacturing robots, by enabling the detection of features of the robot command programming/instruction set that may lead to premature wear of the robot, thus elongating the robot's effective life, reducing robot downtime, and overall increasing the productivity of the robot.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
continuously monitor an electrical current used by a motor of a robot;
compare the electrical current to a secondary electrical current used by the robot;
identify, from the electrical current and the secondary electrical current, an operating inefficiency of a robot command instruction set; and
generate an alteration to the robot command instruction set, the alteration addressing the operating inefficiency.

2. The system of claim 1, wherein the machine-readable instruction that, when executed by the processor, causes the processor to compare the electrical current to the secondary electrical current used by the robot comprises a machine-readable instruction that, when executed by the processor, causes the processor to compare the electrical current to the secondary electrical current using a machine-learning instruction set.

3. The system of claim 1, wherein the machine-readable instruction that, when executed by the processor, causes the processor to identify, from the electrical current and the secondary electrical current, the operating inefficiency of the robot command instruction set comprises a machine-readable instruction that, when executed by the processor, causes the processor to identify the operating inefficiency using a machine-learning instruction set.

4. The system of claim 1, wherein the machine-readable instructions further comprise a machine-readable instruction that, when executed by the processor, causes the processor to alter the robot command instruction set based on a generated alteration.

5. The system of claim 1, wherein:
the secondary electrical current is a current used by the motor at a different point in time;
the operating inefficiency is identified based on a difference between the electrical current and the secondary electrical current; and
the machine-readable instruction that, when executed by the processor, causes the processor to generate the alteration to the robot command instruction set comprises a machine-readable instruction that, when executed by the processor, causes the processor to change an operation of the motor to reduce the difference between the electrical current and the secondary electrical current.

6. The system of claim 1, wherein:
the secondary electrical current is a current used by a different motor of the robot;
the operating inefficiency is identified based on a difference between the electrical current and the secondary electrical current; and
the machine-readable instruction that, when executed by the processor causes the processor to generate the alteration to the robot command instruction set comprises a machine-readable instruction that, when executed by the processor, causes the processor to change an operation of at least one of the motor or the different motor to reduce the difference between the electrical current and the secondary electrical current.

7. The system of claim 1, wherein:
the secondary electrical current is a zero current indicating an idle portion of a cycle of the robot; and
the machine-readable instruction that, when executed by the processor, causes the processor to generate the alteration to the robot command instruction set comprises a machine-readable instruction that, when executed by the processor, causes the processor to reduce an operating speed of the motor to reduce a duration of the idle portion.

8. The system of claim 1, wherein the machine-readable instruction that, when executed by the processor, causes the processor to continuously monitor the electrical current used by the motor of the robot comprises a machine-readable instruction that, when executed by the processor, causes the processor to continuously monitor the electrical current used by each joint motor of a multi-axis robot.

9. The system of claim 1, wherein the machine-readable instructions further comprise:
a machine-readable instruction that, when executed by the processor, causes the processor to rank operating inefficiencies of multiple motors of the robot; and
a machine-readable instruction that, when executed by the processor, causes the processor to select, based on a ranking, the motor of the robot for which the alteration is generated.

10. The system of claim 1, wherein the machine-readable instructions further comprise:
a machine-readable instruction that, when executed by the processor, causes the processor to rank operating inefficiencies of multiple motors of different robots; and
a machine-readable instruction that, when executed by the processor, causes the processor to select, based on a ranking, the motor of the robot for which the alteration is generated.
